(19) United States
(12) Patent Application Publication
(10) Pub. No.: US 2008/0109269 A1
(43) Pub. Date: May 8, 2008

(54) Enterprise Performance Improvement Planning and Execution System

(76) Inventors: Christopher Michael Westwood, Worcester (GB); Paul Anthony Michael Ingram, Aborgavenny (GB)

Correspondence Address: CHRISTOPHER WESTWOOD, THE OLD RECTORY, OMBERSLEY, WORCESTER, WORCESTERSHIRE, WR9 OEW, omitted

(21) Appl. No.: 11/557,107

(22) Filed: Nov. 7, 2006

(51) Int. Cl. G06F 17/50; G06F 9/44

(52) U.S. Cl. 705/7

(57) ABSTRACT

The invention is an online methodology for classifying, searching, validating and assessing solutions resulting in one of more of the following: a reduction in the price of goods consumed across one or more business processes, a reduction in the volume of goods consumed across one or more business processes, a reduction in the price of services consumed across one or more business processes, a reduction in the volume of services consumed across one or more business processes, the generation of revenue across one or more business processes. The methodology comprises the: definition of an enterprise in terms of business processes and physical entities (site types and function types) selected from a library of universal business processes and a universal library of the physical entities the business process model being optionally based upon sector process models selected from the universal library of standardized industries and sectors.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND

1. Field of the Invention

This invention relates generally to an enterprise performance improvement planning and execution system.

2. Description of Prior Art

There exists a need for a data processing system that uses an online methodology for classifying, searching, validating and assessing solutions that results in one or more of the set of:
a. a reduction in the price of goods consumed across one or more business processes;
b. a reduction in the volume of goods consumed across one or more business processes;
c. a reduction in the price of services consumed across one or more business processes;
d. a reduction in the volume of services consumed across one or more business processes;
e. the generation of revenue across one or more business processes.

There currently is not a system that allows this type of service. There is still room for improvement within the art.

### SUMMARY OF THE INVENTION

The invention is an online methodology for classifying, searching, validating and assessing solutions that results in one or more of the set of:
a. a reduction in the price of goods consumed across one or more business processes;
b. a reduction in the volume of goods consumed across one or more business processes;
c. a reduction in the price of services consumed across one or more business processes;
d. a reduction in the volume of services consumed across one or more business processes;
e. the generation of revenue across one or more business processes.

The methodology comprises: the definition of an enterprise in terms of processes selected from a library of universal business processes and physical entities selected from a universal entity library comprising site types and function types the output being an enterprise model; alternatively the enterprise model can be built starting with standardized sector process models. Each sector process model comprises a set of business processes pre assigned from the universal process library.

Sectors are selected from the system's library of standardized industries and sectors; the dynamic, structured and intelligent scheduling of universal business processes prevalent within the enterprise for a cost reduction review; searching, validating and assessing solutions for scheduled business processes; alerting business process owners and managers about suppliers and providers that are capable of implementing solutions that results in one or more of the following:
a. a reduction in the price of goods consumed across one or more business processes;
b. a reduction in the volume of goods consumed across one or more business processes;
c. a reduction in the price of services consumed across one or more business processes;
d. a reduction in the volume of services consumed across one or more business processes;
e. the generation of revenue across one or more business processes.

The process is more intelligent, structured, efficient, effective, and functional than the current art.

### BRIEF DESCRIPTION OF THE DRAWINGS

Without restricting the full scope of this invention, the preferred form of this invention is illustrated in the following drawings:

FIG. 1 shows an overview of the accessing of the system;

FIG. 2 shows the major components of the system; and

FIG. 3 displays the solution classification system.

### DESCRIPTION OF THE PREFERRED EMBODIMENT

Below is the preferred embodiment of the current invention, but it is not the only embodiment of the current invention and should not be read as such.

The present invention relates to system 1 which is an online methodology for classifying, searching, validating and assessing solutions that results in one or more of the following:
a. a reduction in the price of goods consumed across one or more business processes;
b. a reduction in the volume of goods consumed across one or more business processes;
c. a reduction in the price of services consumed across one or more business processes;
d. a reduction in the volume of services consumed across one or more business processes;
e. the generation of revenue across one or more business processes.

The methodology comprises:
a. the definition of an enterprise in terms of processes selected from a library of universal business processes and physical entities selected from a universal entity library comprising site types and function types the output being an enterprise model;
b. alternatively the enterprise model can be built starting with standardized sector process models with each sector process model comprising a set of business processes pre assigned from the universal process library where Sectors are selected from the system's library of standardized industries and sectors;
c. the dynamic, structured and intelligent scheduling of universal business processes prevalent within the enterprise for a cost reduction review;
d. searching, validating and assessing solutions for scheduled business processes;
e. alerting business process owners and managers about suppliers and providers that are capable of implementing the solutions;
f. all resulting in solutions that results in one or more of the following:
   i. a reduction in the price of goods consumed across one or more business processes;
   ii. a reduction in the volume of goods consumed across one or more business processes;
   iii. a reduction in the price of services consumed across one or more business processes;
   iv. a reduction in the volume of services consumed across one or more business processes;
   v. the generation of revenue across one or more business processes.

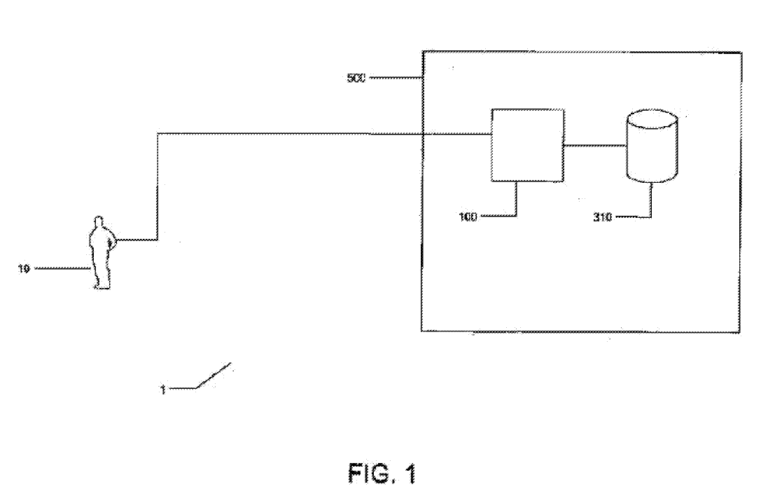

FIG. 1 illustrates a functional diagram of a computer network for Internet 500 access to the System 1 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider often referred to as ISPs, or through an on-line service provider like CompuServe, Prodigy, American Online, etc. or Wireless devices using services like AT&T or Verizon. Each user 10 will have a display device such as a monitor and input device like a keyboard. This display and input device can even be a PDA like a Blackburn

The Users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System Web Site 100.

Output can include a graphical user interface, hardcopy, facsimile, e-mail, messaging or other communication with any humanly or machine discernable data and/or artifacts.

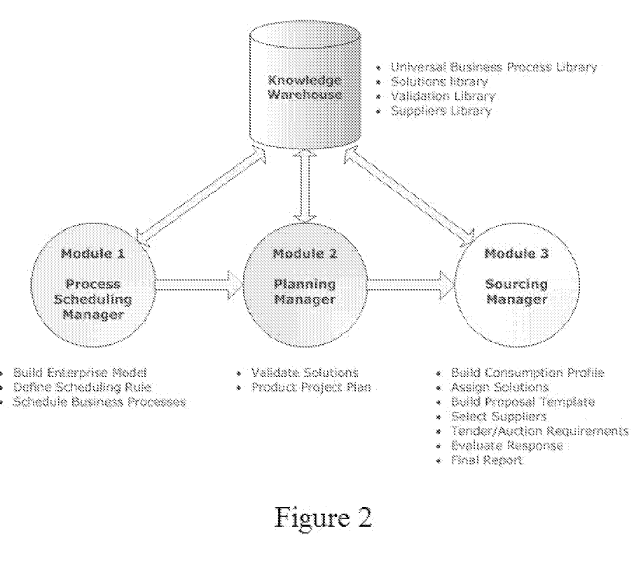

The data processing System 1 allows for secure input, data transfer and storage of a wide array of information. The data processing system 1 embodiments includes computer processing means for processing data, storage means for storing data on a storage medium, and communication means for transferring data in a secure environment. The data processing System 1, as shown in FIG. 2, uses an online methodology for classifying, searching, validating and assessing solutions that reduce the price and volume of goods and services consumed by an enterprise's business processes. The methodology comprises: the definition of an enterprise in terms of processes selected from a library of universal business processes and physical entities selected from a universal entity library comprising site types and function types the output being an enterprise model; alternatively the enterprise model can be built starting with standardized sector process models. Each sector process model comprises a set of business processes pre assigned from the universal process library. Sectors are selected from the system's library of standardized industries and sectors; the dynamic, structured and intelligent scheduling of universal business processes prevalent within the enterprise for a cost reduction review; searching, validating and assessing solutions for scheduled business processes; alerting business process owners and managers about suppliers and providers that are capable of implementing the solutions; resulting in one or more of the following:
a. a reduction in the price of goods consumed across one or more business processes;
b. a reduction in the volume of goods consumed across one or more business processes;
c. a reduction in the price of services consumed across one or more business processes;
d. a reduction in the volume of services consumed across one or more business processes;
e. the generation of revenue across one or more business processes.

The Systems 1 Overall Methodology is Novel and Unique. Within the Methodology are the Following Components that are Specific to this Application:

The invention has a universal library of business processes comprising micro processes, sub processes and master processes.

The invention has a universal library of physical entities comprising site types and function types.

The invention has a universal library of standardized industries and sectors.

The system 1 has a process that enables the enterprise to be modeled in terms of processes selected from a standardized library of universal business processes and enterprise entities selected from a universal entity library comprising sites/functions.

There is a further process for building enterprise models by customizing the system's standardized sector process models to the user's specific needs.

The system 1 has a process that enables the enterprises' business processes (selected from the universal process library) to be intelligently and dynamically and manually scheduled for a cost reduction review and the process owner/manager alerted to conduct the review.

The system 1 has a process to search for and validate the applicability of solutions to an enterprise based on the answers to a series of solution specific validation questions.

The system 1 has a process for assessing the volume and price reduction and revenue generation opportunity for each validated solution.

There is an underlying solution classification system that links solutions to universal processes and enables the effective validation and assessment of volume and price reductions and revenue generation opportunities for validated solutions.

The Functional Process of Each of the System 1 Components is as Follows:

The Universal Business Process Library:

The Universal Business Process Library is the system's library of standardized business processes. In this context a business process is defined as a consumer of purchased goods and services. The library of universal business processes covers all goods and services likely to be consumed by any enterprise.

The business process library is structured according to a logical hierarchy as follows. The micro processes are processes with a homogeneous group of suppliers that can each provide the goods and services consumed by the business process. These are the universal business processes referred to throughout the system 1. (e.g. Micro Process=Consumption of Computer Consumables *therefore Consumption of Computer Consumables is a universal business process). The sub processes are logical groupings of micro processes in an enterprise. The goods and services consumed by a sub process are again serviced by a (larger) homogeneous group of suppliers (e.g. Sub process=Office Consumables). The master processes are logical groupings of sub processes. The goods and services consumed by a master process are again serviced by a (larger still) homogeneous group of suppliers (e.g. Master process=Consumables). To summarize:

Micro-processes: These are the universal business processes referred to throughout. (e.g. Micro Process 130=Consumption of Computer Consumables *therefore Consumption of Computer Consumable is a universal business process).

Sub Processes: The goods and services consumed by a sub process are again serviced by a (larger) homogeneous group of suppliers (e.g. Sub process 140=Office Consumables).

Master Processes: The goods and services consumed by a master process are again serviced by a (even larger) homogeneous group of suppliers (e.g. Master process 150=Consumables).

In the preferred embodiment, there are about 1000 standardized micro processes within the universal business process library.

Universal Library of Standardized Industries and Sectors:

In order to build standardized sector process models the System 1 has a universal; library of industries and sectors. e.g. Industry=Health Services; Sector=Hospitals.

In the preferred embodiment, there are about 300 sectors within the universal industry library.

Modeling the enterprise:

To create the enterprise model the system enables business processes from the universal business process library to be mapped on to entities from the universal entity library (sites/functions).

Enterprise data is added to the enterprise model including process owner, site or function heads, process scheduling rules, process budgets and expenditure levels on goods and services consumed by the processes in the enterprise model.

The enterprise model comprising sites functions and assigned business processes is depicted as a physical representation of the enterprise. In the system 1 a physical (visual) representation of the enterprise is defined in terms of site types and functions and their hierarchical relationship to each other and the business processes assigned to each physical entity.

Building enterprise models from standardized sector process models:

The standardized sector process models comprise processes assigned from the system's universal business process library to sectors defined in the system's universal industry sector library 110. The user can select the sector to which their enterprise belongs. The relevant universal sector process model is then customized to become an “enterprise specific” model. Customization comprises the addition of business processes assigned to the standardized sector process model from the universal business process library or the removal of business processes pre assigned to the sector process model. Enterprise data is then added to the enterprise model including process owner, site or function heads, process scheduling rules, process budgets and expenditure levels on goods and services consumed by the processes in the enterprise model. The output is a “my enterprise processes model” defined in terms of its universal business processes.

Scheduling Business Processes for a Cost Reduction Review:

Each of the universal business processes in the enterprise model is subject to a scheduling regime. The scheduling regime alerts the business process owner/manager that a specific business process in a specific site or function within the enterprise is due for a cost reduction review. In the preferred embodiment, the enterprise scheduling regime comprises “Standard scheduling rules”, “User defined scheduling rules” and “external trigger” base process scheduling. Scheduled processes with the rationale for being scheduled are viewable on request in the preferred embodiment.

The types of “Standard scheduling rules” comprise methods such as “due date scheduling” and “over-budget scheduling”.

“Due date scheduling” is where universal business processes within the enterprise are scheduled for review at defined intervals. The review interval reflects the volatility of factors that affect the cost of goods and services consumed by the universal business process. For example, telecommunications processes offer frequent opportunity for cost reduction reviews due to technology change and economic factor change such as market deregulation, so the interval would be short. Office supplies consumption is a less volatile process with technology and economic factors having little influence, so the due date interval would be longer. The “due date scheduling rule” incorporates a preset scheduling interval for each universal business process, the interval having been defined by the system 1 based on these factors.

With “over-budget scheduling” if the actual cost of goods and services consumed by a universal business process exceeds budgeted cost the universal business process is auto scheduled for a cost reduction review.

With “user defined scheduling rules” the user 10 can implement their own scheduling rules based on factors that affect their enterprise 20. The user 10 might manually select/schedule a micro process, a sub process or a master process for review. In the latter two cases where there are multiple micro processes scheduled the methodology will prioritize the micro processes to be reviewed according to a simple heuristic comprising expenditure levels and length of time since last review.

“External triggers” are electronic triggers that alert the entire community of users that a solution has emerged that may yield a reduction in the price or volume of goods and services consumed by one or more of the universal business processes or a revenue generation opportunity. For example, the advent of voice over internet (VOIP) is a possible solution across the voice telecommunications consumption business process. In the preferred embodiment, any authorized member of the community of users can attach a new solution to an electronic external trigger. The trigger then searches the entire community for enterprise models that contain the relevant universal business process. In the example enterprise models incorporating the universal business process voice telecommunication consumption is searched for. Once the trigger finds an instance of the solution-associated universal business process, the system will schedule that universal business process for a review on behalf of that enterprise.

Attached to the external trigger are suppliers capable of providing the solution in the region that the enterprise and universal business process owner are located. Suppliers may pay for their right to be attached to the external trigger, the payment amount being a function of the supplier's relative prominence on the trigger. Universal business processes that are scheduled due to an external trigger are alerted to the universal process owner/manager and the enterprise executive with overall responsibility for cost reduction. The alerted process owner/manager and executive are also alerted to the specific solution (in the example the VOIP technology) and to capable providers/suppliers of that solution in that geographical region. The process owner/manager or executive will decide whether to initiate a process review based on the external trigger.

To summarize the external trigger scheduling process:

Any (authorized) member of the community of users 10 can attach the solution to an electronic external trigger. The trigger then searches the entire community for enterprise models that contain the relevant universal business process. In the example enterprise models incorporating the universal business process, voice telecommunication consumption are searched for.

Once the trigger finds an instance of the [solution-associated] universal business process, it will schedule that universal business process for a review on behalf of that enterprise.

Attached to the trigger are suppliers capable of providing the solution in the region that the enterprise and universal business process owner are located.

Scheduled universal business processes are alerted to the universal process owner/manager and the enterprise executive responsible for cost reduction.

The alerted process owner/manager and executive are also alerted to the specific solution (in the example the VOIP technology) and capable providers/suppliers of that solution in that geographical region. The process owner/manager or executive then decide whether to initiate a process review based on the solution attached to the trigger.

Searching for and Validating Solutions:

Each of the universal business processes under review is subjected to a validation process 175. The validation process 175 assesses whether each solution attached to the universal business process under review is likely to be relevant to the user's enterprise. Each solution assigned to the universal business process under review is validated if certain conditions within the enterprise are met. The validation process 175 assigned to each solution therefore assesses whether those conditions are met (or not). Thus for each scheduled business process the assigned solutions within the knowledge warehouse are validated according to a pre-set validation procedure comprising one or more validation questions.

An example of a validation process is:

Universal Business Process=printed business form consumption

Solution=source high volume printed forms using web printing technology Validation 1=are any print runs greater than xxx forms? If yes, solution validates. Once the validation process is completed, the system 1 will allow a user to build a project plan. The project plan defines the universal business process(es) under review the validated solutions, an estimate of the business process price and volume reduction and revenue generation opportunity and a list of providers/suppliers potentially capable of implementing some or all of the solutions.

Assessing the price and volume reduction for validated processes: Once the system 1 has validated solutions for scheduled processes the System 1 now assesses the specific price and volume reduction. The process for assessing actual volume and price reductions is as follows. The user 10 will build a cost consumption profile by populating a cost consumption template. The cost consumption template is either developed using the system's cost profile template development tool or selected from the pre-built cost consumption templates in the system 1 knowledge warehouse. Cost consumption templates are linked in the knowledge warehouse to both universal business processes and associated solutions.

The cost consumption template is a spreadsheet-like data entry and analysis tool dedicated to profiling the costs and volumes of goods and services consumed by a universal business process. As such, it facilitates data entry in respect to goods and services consumed by the universal business process and the development of cost profiles based on pricing and volume parameters and formula. The profile of goods and services consumed by the universal process is now entered typically extracting data from invoice records. The profile comprises the volumes and price or price calculation formula. For example, in the office supplies consumption, each office supplies product such as pens and paper is defined along with usage volumes and the unit price paid for each. For the electricity consumption process (with just one product line item) the volume (kilowatts) of energy is entered and the template calculates price based on a pre-populated formula that consider the multiple electricity pricing parameters.

Once the consumption profile has been developed, the price and volume solutions the users wishes to assess are assigned to it. Solutions can be assigned to specific line items in the consumption profile or to the whole profile.

The populated consumption profile is transformed into a requirement specification along with the solutions to be assessed. This document is called the proposal template Capable suppliers within the knowledge warehouse that are linked to validated solutions are (subject to user acceptance) invited to make a proposal. The system 1 incorporates both a reverse auction and tendering engine to facilitate the invitation to propose made to these suppliers. Users 10 can also add their own suppliers.

The proposal template is either sent to suppliers in the form of an electronic tender or posted on the system's reverse auction site. Suppliers are invited to propose for each solution. The results are assessed in terms of price and volume reductions and revenue generation. In addition a balanced scorecard analysis of responses is possible so facilitating non financial analysis factors. The optimal solution or group of solutions is chosen for implementation. A final report is produced. The entire audit trail 320 of the project is posted onto the archive files for future reference and reporting.

Solution Classification Process:

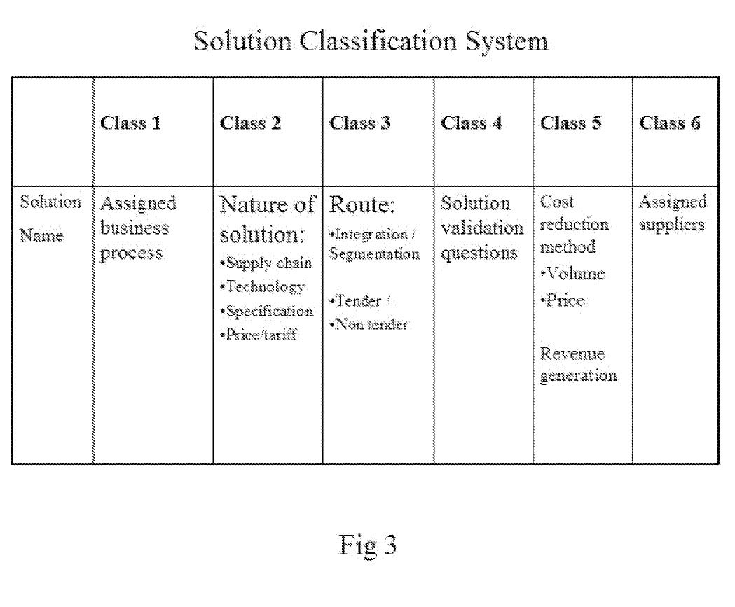

In the System 1 context a solution is a technique that will reduce the price of the goods or services consumed by the specific business process to which it is linked (example solution: source paper from a low cost economy; this solution is linked to the office supplies consumption process) or reduce the volume of the goods or services consumed by the specific business process to which it is linked (example solution: implement power factor correction to reduce electricity consumption; this solution is linked to the electricity consumption process) or create a revenue generation opportunity across the business process. (example solution: generate a supplier commission for routing inbound voice calls via a nominated supplier, this solution is linked to the voice telecommunications process). The system's knowledge warehouse comprises a dynamic library of solutions, each solution being classified according to the six-class system as shown in FIG. 3.

The System 1 has a classification system that enables solutions to be linked to universal processes, validated and routed through each step in the system methodology depending on the nature of the solution. The classification system thus enables the system to effectively search for solutions, validate them then make an assessment of the price and volume reduction and revenue generation opportunity.

Classification Parameter 1 is the Universal Business Process to which the Solution applies. Each cost reduction solution will be relevant to just one of the standard business processes in the Universal Business Process Library. Thus this element of the classification system assigns each solution to its associated business process.

Classification Parameter 2 defines the technical nature of solution. Specifically each solution is assigned to one of the following solution types:

Supply chain solutions: are solutions that result in the supply chain being reconfigured (for example, the removal of process elements that add no value but consume cost).

Specification solutions: are solutions that result in the specification of the goods and services flowing across the supply chain being changed (for example, a change from branded to non-branded products).

Technology solutions: are solutions that result in a change to the technology underpinning processes in the supply chain (for example, a change to from litho to web based printers for high volume print runs).

Price/Tariff solutions: are solutions that result in the way in which the price or tariff is configured (for example, implementing open book pricing methods or the selection of an alternative tariff configuration).

Classification Parameter 3 defines parameters that effect the route the Solution follows through methodology. The route is dependent upon which of the following classification parameters is assigned to the solution:

Integration and Segmentation Solutions: for example if the scheduled business process is office supplies consumption, then a potential solution is to integrate it with the computer supplies consumption process and seek a single source of supply for both. Thus both of these universal business processes need to be reviewed together (integrated) for this solution to be effectively assessed. Alternatively if two or more micro processes have been combined under one supplier, they could be broken out into two distinct micro processes and reviewed separately. In both cases more than one micro process needs to be reviewed in parallel to assess the effectiveness of the solution. Thus the system will force the scheduling of associated micros for these solution types. This means re routing the user back through the validation process for the extended process review and ensuring associated processes are always tagged to each other.

Tender Solutions are those that need to be costed through a supplier tendering or auction process. For example, changing the specification of a business form from 3 to 2 colors requires a supplier costing. Therefore the solution needs to be subjected to the tendering or auction process components of the methodology.

Non Tender Solutions may not require to be tendered for costing (e.g. a technology solution might reduce energy consumption). Therefore the solution will “pass by” the tender process.

Classification Parameter 4 is the validation process for each solution. The validation process defines whether the business conditions needed for the solution to be worth further consideration have been met. The validation process comprises a series of questions where the answers are used by the system to validate or reject the solution. Thus for each solutions within the knowledge warehouse there is an assigned validation procedure.

Classification Parameter 5 describes whether the solution impacts the volume or the price of the goods and services consumed or generates a revenue opportunity.

Classification Parameter 6 is the Supplier assignment. Each solution in the warehouse is attached to suppliers capable of providing the solution.

Advantages

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A data processing system comprising;
classifying, searching, validating and assessing solutions that results in one or more of the set of:
a reduction in the price of goods consumed across one or more business processes;
a reduction in the volume of goods consumed across one or more business processes;
a reduction in the price of services consumed across one or more business processes;
a reduction in the volume of services consumed across one or more business processes;
the generation of revenue across one or more business processes.

2. A data processing system according to claim 1 further comprising the definition of the enterprise in terms of business processes selected from a library of universal business processes and physical entities selected from a library of universal physical entities (sites and functions)

3. A data processing system according to claim 1 further comprising a method for defining the enterprise process model by customizing a sector process model selected from a universal library of standardized industries and sectors

4. A data processing system according to claim 1 further having the functionality to intelligently and systematically and manually schedule business processes for a cost reduction and revenue generation review.

5. A data processing system according to claim 1 further comprising a methodology for searching and validating solutions for scheduled business processes.

6. A data processing system according to claim 1 further comprising alerting business process owners and managers about suppliers and providers that have the capability to provide the solutions.

7. A data processing system according to claim 3 further comprising a Universal library of standardized Industries and Sectors.

8. A data processing system according to claim 7 further having each of said sectors comprising business processes prevalent in the sector said processes being selected from the universal business process library.

9. A data processing system according to claim 2 further comprising said library of universal business processes having master processes, sub processes and micro processes.

10. A data processing system according to claim 9 further comprising said micro processes each micro process having a homogeneous group of suppliers.

11. A data processing system according to claim 10 further comprising said group of homogenous suppliers each supplier in the group being able to supply the goods and services consumed by the micro process.

12. A data processing system according to claim 9 further comprising said sub processes that are logical groupings of micro processes.

13. A data processing system according to claim 9 further comprising said master processes being logical grouping of sub processes

14. A data processing system according to claim 9 further comprising a library of universal business processes each process being a consumer of goods and services

15. A data processing system according to claim 1 further having a user definable enterprise business process model

16. A data processing system according to claim 15 further comprising said enterprise business process model having business processes being selected from the universal business process library.

17. A data processing system according to claim 1 further having a business process scheduling tool.

18. A data processing system according to claim 17 further comprising said scheduling tool having due date scheduling and over-budget scheduling methods.

19. A data processing system according to claim 18 further comprising said due date scheduling method comprising review intervals based on one or more of a set or economic, technological, financial, supply chain factors and other influential factors.

20. A data processing system according to claim 18 further comprising said over-budget scheduling method comprising a method for capturing actual expenditure on the goods and services consumed by a universal business process and comparing that with budgeted expenditure creating a process schedule in the event of an over budget outcome.

21. A data processing system according to claim 17 further comprising said scheduling tool having a scheduling method based on external triggers.

22. A data processing system according to claim 21 further having said external triggers comprising a solution linked to a business process selected from the universal business process library.

23. A data processing system according to claim 22 further having said external trigger that can search the user community for enterprise models with said business process.

24. A data processing system according to claim 23 further having a function for scheduling said business process when the search engine finds an enterprise model with said business process.

25. A data processing system according to claim 24 further having said external trigger having a supplier list, each supplier on the supplier list being able to provide the said solution

26. A data processing system according to claim 25 further having an algorithm for giving said suppliers priority status on the said supplier list, said priority status being relative to the advertising fee said supplier pays.

27. A data processing system according to claim 17 further comprising an alert to one or more of the set of the process owner or manager that a business process has been scheduled.

28. A data processing system according to claim 1 further having a solution classification system

29. A data processing system according to claim 28 further having said solution classification system having each solution being classified as a supply chain solution or a technology solution or a specification solution or a price/tariff solution.

30. A data processing system according to claim 28 further having said solution classification system having each solution classified as a volume reduction solution or a price reduction solution or a revenue generation solution.

31. A data processing system according to claim 28 further having said solution classification system having some solutions classified as integration or segmentation solutions such solution types requiring multiple micro process to be reviewed together.

32. A data processing system according to claim 31 further having said integration solutions and said segmentation solutions auto scheduling a review of associated micro processes.

33. A data processing system according to claim 32 further having said associated micro processes associated by virtue of a homogeneous group of suppliers each supplier in the group able to provide the goods and services consumed by each of the associated micro process

34. A data processing system according to claim 28 further having said solution classification system having each solution classified as either tender or non tendered solutions.

35. A data processing system according to claim 34 further having said tendered solutions defined by virtue of the solution requiring a supplier proposal in order to assess the solution's impact on the price or volume of the goods or services consumed or the solution's revenue generation opportunity.

36. A data processing system according to claim 34 further having said non tendered solutions defined by virtue of the solution not requiring a supplier proposal in order to assess the solution's impact on the price or volume of the goods or services consumed or the solution's revenue generation opportunity.

37. A data processing system according to claim 28 further having a method of assessing each solution's impact on the price or volume of the goods or services consumed or the solution's revenue generation opportunity depending on each solution's classification.

38. A data processing system according to claim 1 further having validation routines for each solution.

39. A data processing system according to claim 38 further having said validation routines each validation routine comprising a series of questions the answers to which ascertain the validity of a specific solution to the enterprise being reviewed.

40. A data processing system according to claim 1 further having a database comprising solutions.

41. A data processing system according to claim 40 further having suppliers capable of providing the solutions to which the supplier is linked.

42. A data processing system according to claim 1 further having consumption profile templates for capturing the profile of volumes and prices for goods and services consumed by a universal business process.

43. A data processing system according to claim 42 further having a process for designing said consumption profile templates.

44. A data processing system according to claim 43 further having said process for designing said consumption profile templates having a pricing formulae generator

45. A data processing system according to claim 42 further having said consumption profile having a consolidation tool for aggregating profiles of goods and services that are the same.

46. A data processing system according to claim 42 further having said consumption profile having a method for assigning volume solutions to each of the goods or services in the consumption profile or globally to the entire consumption profile.

47. A data processing system according to claim 46 further having said volume solution assignment to also have a method for recalculating volume requirements based on either user inputs or a formula.

48. A data processing system according to claim 42 further having said consumption profile having a method for assigning price and revenue generation solutions to each of the goods or services in the consumption profile or globally to the entire consumption profile.

49. A data processing system according to claim 1 further having a proposal template for defining the requirement and solutions and capturing and comparing supplier proposals for the provision of each solution.

50. A data processing system according to claim 1 further having a reporting method for summarizing each suppliers volume and price reduction and revenue generation proposals.

51. A data processing system comprising;
solutions that results in one or more of the set of: a reduction in the price of goods consumed across one or more business processes, a reduction in the volume of goods consumed across one or more business processes, a reduction in the price of services consumed across one or more business processes, a reduction in the volume of services consumed across one or more business processes, the generation of revenue across one or more business processes; a library of universal business processes having master processes, sub processes and micro processes each micro process having a group of homogenous suppliers each supplier being able to supply the goods and services consumed by the micro process; sub processes that are logical groupings of micro processes; master processes being logical grouping of sub processes; each process in the universal business process library being a consumer of goods and services; a Universal library of standardized industries and sectors each sector comprising business processes prevalent in the sector said processes being selected from the universal business process library; the definition of the enterprise in terms of business processes and physical entities (sites and functions) selected from the library of universal business processes and the library of universal physical entities; a method for defining the enterprise process model by customizing a sector process model selected from a universal library of standardized industries and sectors; the functionality to intelligently and systematically and manually schedule business processes for a cost reduction and revenue generation review comprising a business process scheduling tool having due date scheduling comprising review intervals based on one or a more of economic, technological, financial, supply chain factors or other influential factors; over-budget scheduling methods comprising a method for capturing actual expenditure on the goods and services consumed by a universal business process and comparing that with budgeted expenditure creating a process schedule in the event of an over budget outcome; a scheduling method based on external triggers comprising a solution linked to a business process; external triggers that can search the user community for enterprise models with said business process; scheduling said business process when the search engine finds an enterprise model with said business process; external triggers having a supplier list, each supplier on the supplier list being able to provide the said solution; an algorithm for giving suppliers priority status on the supplier list the priority status being relative to the advertising fee the supplier pays; an alert to the process owner and/or manager that a business process has been scheduled; a methodology for searching and validating solutions for scheduled business processes; validation routines for each solution each validation routine comprising a series of questions the answers to which ascertain the validity of a specific solution to the enterprise; alerting business process owners and managers about suppliers and providers that have the capability to provide the solutions; a method of assessing the volume reduction and price reduction and revenue generation each solution yields depending on each solution's classification comprising consumption profile templates for capturing the profile of volumes and prices for goods and services consumed by a universal business process; a process for designing said consumption profile templates having a pricing formulae generator; a consolidation tool for aggregating profiles of goods and services that are the same; a method for assigning volume solutions to each of the goods or services in the consumption profile or globally to the entire consumption profile to also having a method for recalculating volume requirements based on either user inputs or a formula; a method for assigning price and revenue generation solutions to each of the goods or services in the consumption profile or globally to the entire consumption profile; a proposal template for defining requirements and solutions, capturing and comparing supplier's proposals for each solution; a reporting method for summarizing each suppliers volume and price reduction and revenue generation proposal; a solution classification system each solution being classified as either a supply chain solution, technology solution, specification (of goods and services) solution or price/tariff solution; said solution further classified as either a volume reduction solution or price reduction solution or revenue generation solution; some of said solutions further classified as either integration or segmentation solutions said integration and segmentation solutions auto scheduling a review of associated micro processes associated by virtue of a homogeneous group of suppliers each supplier in the group able to provide the goods and services consumed by each associated micro process; said solutions further classified as either tender or non tendered solutions; tendered solutions defined by virtue of the solution requiring a supplier proposal in order to assess the solution's impact on the price or volume of the goods consumed; non tendered solutions defined by virtue of the solution not requiring a supplier proposal; a database comprising solutions each solution having suppliers capable of providing the solutions to which the supplier is linked, all resulting in an assessment of the validated solutions' impact on price and volume of goods or services consumed by a business process and the generation of revenue across a business processes
